(19) United States
(12) Patent Application Publication
(10) Pub. No.: US 2009/0016589 A1
(43) Pub. Date: Jan. 15, 2009

(54) Computer-Assisted Detection of Colonic Polyps Using Convex Hull

(75) Inventors: Matthias Wolf, Coatesville, PA (US); Marcos Salganicoff, Bala Cynwyd, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 12/169,781

(22) Filed: Jul. 9, 2008

Related U.S. Application Data
(60) Provisional application No. 60/948,764, filed on Jul. 10, 2007.

(51) Int. Cl. G06K 9/00

(52) U.S. Cl. 382/131; 382/128

(57) ABSTRACT

A method for performing computer-assisted diagnosis includes receiving a plurality of two-dimensional views of an internal structure, defining a search space around one or more areas of analysis within each view of the internal structure, calculating a convex hull for each area of analysis within each search space of each view of the internal structure, determining a set of foreground pixels that are located within the convex hull for each area of analysis within each search space within each view of the internal structure, and for each area of analysis, merging the set of foreground pixels that are located within the convex hull from each view.

### CROSS-REFERENCE TO RELATED APPLICATION

The present application is based on provisional application Ser. No. 60/948,764, filed Jul. 10, 2007, the entire contents of which are herein incorporated by reference.

### BACKGROUND OF THE INVENTION

1. Technical Field

The present disclosure relates to computer-assisted detection and, more specifically, to computer-assisted detection of colonic polyps using convex hull.

2. Discussion of Related Art

Computer-assisted diagnosis (CAD) is the process of using computers to analyze medical images and automatically detects structural features that may be indicative of disease. CAD may thus combine radiographic imaging techniques and artificial intelligence to detect and classify disease in a non-invasive way.

CAD may begin with the acquisition of medical image data using one or more imaging modality. For example, images may be acquired using two-dimensional modalities such as conventional x-rays or images may be acquired using three-dimensional modalities such as computed tomography (CT) or magnetic resonance imaging (MRI). The image data may then be analyzed using one or more CAD techniques to identify regions of suspicion. Regions of suspicion may represent internal structures that have an elevated likelihood of being subject to disease.

A medical practitioner, for example, a radiologist, may then review the medical image data and the identified regions of interest to determine whether disease is present and to devise a course of treatment. Accordingly, the medical practitioner may use CAD to identify portions of the medical image that may deserve special attention.

Effective CAD may therefore lead to more efficient and accurate diagnosis of disease and may thus contribute to less costly and more accurate medical care.

One field in which CAD has been applied is virtual colonoscopy (VC). In VC, three-dimensional image data of a patient's colon is analyzed to diagnose colon and bowel disease, including polyps, diverticulosis and cancer. In conventional VC, the three-dimensional image data is rendered to produce an image of the colon from the point of view of an imaginary camera located within the lumen of the colon. The medical practitioner may then examine a virtual fly-through whereby sequential images are presented as if the imaginary camera is moved through the colon lumen. If, for example, the medical practitioner identified what might be a polyp, a conventional colonoscopy may be performed to further examine the potential polyp and, if necessary, remove it.

As applied to virtual colonoscopy, CAD may be used to highlight regions of suspicion within the rendered fly-through images. Alternatively, CAD may be used to highlight regions of suspicion in a two-dimensional image slice of the medical image data. In either case, CAD techniques may be employed to direct the medical practitioner's attention to any discovered regions of suspicion so that a diagnosis may be rendered.

Another field in which CAD has been applied to is the detection of disease within the lungs. Here, three-dimensional image data of a patient's lungs is analyzed to diagnose lung disease including pleura-attached nodules. As described above, CAD techniques may be employed to direct the medical practitioner's attention to any discovered regions of suspicion within the lungs so that a diagnosis may be rendered.

After one or more regions of suspicion have been identified, the CAD system may be designed to provide additional details concerning each identified region of suspicion. These details may be structural, statistical, and/or include any other data or characterization of the region of suspicion that may be of diagnostic interest.

### SUMMARY

A method for performing computer-assisted diagnosis includes acquiring medical image data, detecting one or more candidates within the medical image data, defining a search space around each detected candidate, calculating a convex hull for each candidate within each search space, determining a set of pixels that are located within the convex hull for each candidate within each search space, and calculating one or more properties concerning the candidates based on the sets of pixels within the convex hulls.

The medical image data may be CT image data, MR image data, ultrasound image data, or PET image data. The one or more candidates may be polyp candidates. The size of each defined search space may be based on the approximate size of a polyp.

The medical image data may include a plurality of views and the detection of the one or more candidates may be performed within each view of the medical image data. A separate search space may be defined around each detected candidate in each view. The convex hull may be calculated for each candidate within each search space within each view. The sets of pixels located within the convex hull may be determined for each candidate in each view. The one or more properties concerning each candidate may be calculated by first merging the sets of pixels of each particular candidate from all views.

The plurality of views may include a sagittal view, a coronal view, and an axial view. The one or more properties concerning the candidates may include a three-dimensional size of the candidate. The calculated one or more properties concerning the candidates may be used to render a diagnosis regarding each candidate. The medical image data may include a colon and the one or more candidates may be colonic polyp candidates.

A method for performing computer-assisted diagnosis includes acquiring a plurality of two-dimensional views of an internal structure, detecting one or more candidates within each view of the medical image data, defining a search space around each detected candidate within each view of the medical image data, calculating a convex hull for each candidate within each search space of each view of the medical image data, determining a set of pixels that are located within the convex hull for each candidate within each search space within each view of the medical image data, for each candidate, merging the set of pixels that are located within the convex hull from each view, and calculating a three-dimensional size for each candidate based on the corresponding merged set of pixels.

The plurality of two-dimensional views of the structure may be rendered from a three-dimensional medical image. The plurality of two-dimensional views may be acquired from CT image data, MR image data, ultrasound image data, or PET image data. The one or more candidates may be polyp candidates. The size of each defined search space may be based on the approximate size of a polyp. The plurality of views may include a sagittal view, a coronal view, and an axial view.

The three-dimensional size calculated for the candidates may be used to render a diagnosis regarding each candidate. The internal structure may include a colon and the one or more candidates may be colonic polyp candidates.

A computer system includes a processor and a program storage device readable by the computer system, embodying a program of instructions executable by the processor to perform method steps for performing computer-assisted diagnosis. The method includes acquiring a plurality of two-dimensional views of an internal structure, detecting one or more candidates within each view of the medical image data, defining a search space around each detected candidate within each view of the medical image data, calculating a convex hull for each candidate within each search space of each view of the medical image data, determining a set of pixels that are located within the convex hull for each candidate within each search space within each view of the medical image data, for each candidate, merging the set of pixels that are located within the convex hull from each view, and calculating a three-dimensional size for each candidate based on the corresponding merged set of pixels.

The one or more candidates may be polyp candidates and the size of each defined search space may be based on the approximate size of a polyp. The plurality of views may include a sagittal view, a coronal view, and an axial view.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a diagram illustrating the determination of a convex hull boundary for the pixels comprising a colon wall, the lumen of the colon is interior to the boundary;

FIG. 2 is a sequence of views taken from CT medical image data illustrating a polyp candidate on a colon wall;

FIG. 3 is the sequence of views taken from CT medical image data of FIG. 2 wherein small search spaces are defined around the polyp candidate in each view according to an exemplary embodiment of the present invention;

FIG. 4 is the sequence of views taken from CT medical image data of FIG. 2 wherein large search spaces are defined around the polyp candidate in each view according to an exemplary embodiment of the present invention;

FIG. 5 is a flow chart illustrating a method for detecting and characterizing colonic polyps according to an exemplary embodiment of the present invention; and

FIG. 6 shows an example of a computer system capable of implementing the method and apparatus according to embodiments of the present disclosure.

### DETAILED DESCRIPTION OF THE DRAWINGS

In describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present invention seek to provide a quick and accurate approach for locating and characterizing regions of suspicion from medical image data. A region of suspicion, as used herein, may mean any identified structure that is discovered to have an elevated risk of indicating the presence of disease. For example, a region of suspicion may be a structure protruding from a colon wall that appears to be polyp like. Identification of the region of suspicion may be performed by the CAD system and a medical practitioner may then review the medical image data and the identified regions of suspicion to render a diagnosis.

Medical image data, as used herein, may mean two-dimensional or three-dimensional characterizations of the internal structure or function of a patient. Medical image data may be acquired from a medical imaging device. Medical image data is generally digital data, and may be acquired either by direct digital reading or by digitization of an analog medical image.

Exemplary embodiments of the present invention may be applied to medical image data that has been acquired from any medical imaging device. For example, exemplary embodiments of the present invention may use medical image data that is a result of computed-tomography (CT), magnetic resonance (MR), ultrasound, positron emission tomography (PET), as well as medical image data from other sources.

After regions of suspicion are identified from the medical image data, a medical practitioner such as a radiologist may review the medical image data to render a diagnosis. In rendering a diagnosis, the medical practitioner may pay more careful attention to the areas identified as regions of suspicion. In this way, CAD systems may lead to faster and more accurate diagnosis of disease based on medical image data.

Besides identifying regions of suspicion, CAD systems according to exemplary embodiments of the present invention may also provide data of diagnostic significance that may be calculated from the medical imaged data and presented to the medical practitioner to help render a diagnosis. This data may pertain to the medical image data in general and/or may be particular for each identified region of suspicion. For example, where the region of suspicion is a polyp candidate, the CAD system may be used to provide an accurate assessment of the three-dimensional size of the polyp candidate. Moreover, the CAD system may also be used to characterize each region of suspicion, for example, the CAD system may be used to identify that the region of suspicion is in fact a polyp.

After medical image data has been acquired, the medical image data may be rendered in a particular view that is well suited for viewing regions of suspicion. For example, in the case of analyzing the colon, the medical image data may be arranged as either a set of two-dimensional image slices representing cross sections of the colon, or as a three-dimensional virtual fly-through. In such a case, the walls of a cross section of the colon may be visible. Any colonic polyps or other areas of potential disease may also be observable from this image view.

Examples of suitable views may include sagittal, coronal, and axial views. Multiple views may also be used, for example, to corroborate findings or to characterize a three-dimensional structure based on multiple two-dimensional views.

After the medical data has been rendered such that at least a section of the contour of the colon wall is visible, a search space may be defined, for example as described in detail below. A convex hull may be determined around the set of pixels that comprise the colon wall within the search space. The convex hull is defined as the minimal convex subset of contour points from the colon wall contour point set, where the entire cross-sectional circumference of the colon wall is in view, the convex hull may appear as a substantially circular (convex) shape where structures such as folds, polyps, etc. would be located inside the convex hull.

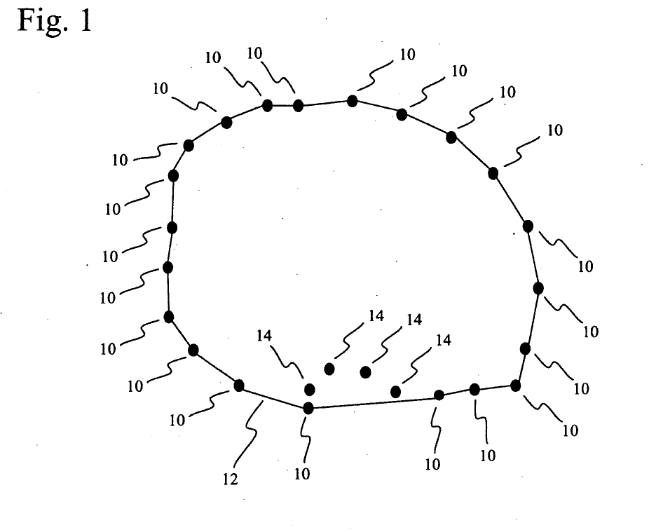

FIG. 1 is a diagram illustrating the determination of a convex hull for the pixels comprising a colon wall. The lumen of the colon is interior to the colon wall, and areas of the abdomen outside of the colon lumen are exterior. Each of the dots 10 and 14 represent a pixel of the colon wall. The shape 12 represents the convex hull boundary calculated for the set of dots 10 and 14, wherein the dots 10 intercept the convex hull 12 and the dots 14 are within the convex hull 12. The convex hull may be calculated according to techniques known in the art.

The pixels of the medical image data may be characterized as either foreground pixels or background pixels based on domain knowledge. For example, pixels outside of the colon lumen may be labeled as foreground pixels. After the convex hull has been calculated, foreground pixels interior to the calculated convex hull may be considered to form regions of suspicion, for example, polyp candidates.

Alternatively, if only the surface pixels of structures within the convex hull need to be identified, then only boundary pixels excluded from the convex hull boundary set of points will suffice.

The convex hull may accordingly be used to separate locally concave objects and structures from a convex overall surface such as the colon lumen. Alternatively, the convex hull may also be used to locate convex objects from concave surfaces or structures by inverting the foreground/background assignment of pixels. For example, the dots 10 that intercept the convex hull 12 may represent a normal surface of the colon while the dots 14 located within the convex hull 12 may represent folds, polyps, etc. and may thus be considered part of a region of suspicion. Accordingly, a region of suspicion, for example a polyp candidate, may be segmented and/or characterized with the help of the convex hull.

A single region of suspicion may be analyzed according to the convex hull in multiple views. The multiple views may include views from multiple angles, a sequence of two-dimensional image slices, or may include successive frames in a virtual fly-through rendering. At each view, information concerning the shape of the region of suspicion may be acquired. The segmentation and shape information from the multiple views may then be combined to obtain a three-dimensional segmentation of the region of suspicion and/or estimations of other features such as the three-dimensional size of the region of suspicion.

Exemplary embodiments of the present invention are described herein with reference to the detection and characterization of polyps within the colon; however, the invention is not limited thereto. Exemplary embodiments of the present invention may be applied to identifying, segmenting and characterizing regions of suspicion within any convex structure at a scale larger than that of the locally concave region of interest, such as substantially spherical, ellipsoidal, or tubular structures.

When exemplary embodiments of the present invention are applied to the detection and characterization of colonic polyps, useful views may include sagittal, coronal, and axial views.

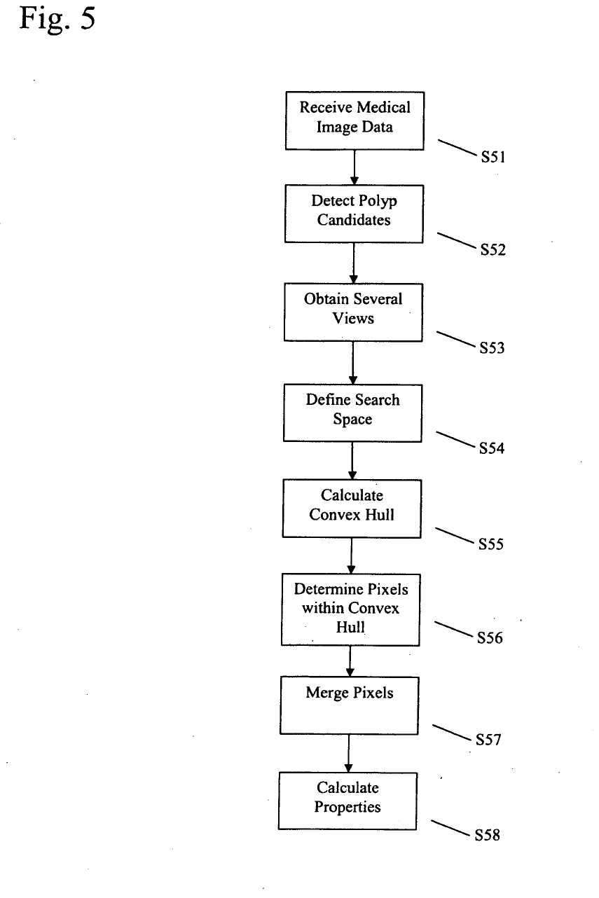

According to exemplary embodiments of the present invention, a CAD system may be used to detect and/or characterize colonic polyps. FIG. 5 is a flow chart illustrating a method for detecting and characterizing colonic polyps according to an exemplary embodiment of the present invention. It is to be understood that while the detection of colonic polyps is offered as an example, this approach may easily be applied to the detection and characterization of other structural aspects. First medical image data may be received (S51). The medical image data may be from any source or modality, for example, the medical image data may be CT image data. The medical image data may also be divided into foreground pixels and background pixels based on domain knowledge, or using any one of a number of segmentation algorithms known in the art. Then, one or more polyp candidates may be found (Step S52), for example, using known CAD approaches for the automatic detection of polyps. These CAD techniques may result in the identification of one or more polyp candidates.

Next, for each polyp candidate, the medical image data may be rendered into one or more views (Step S53). The views may each show the polyp candidate from a different angle. For example, sagittal, coronal, and axial views may be rendered.

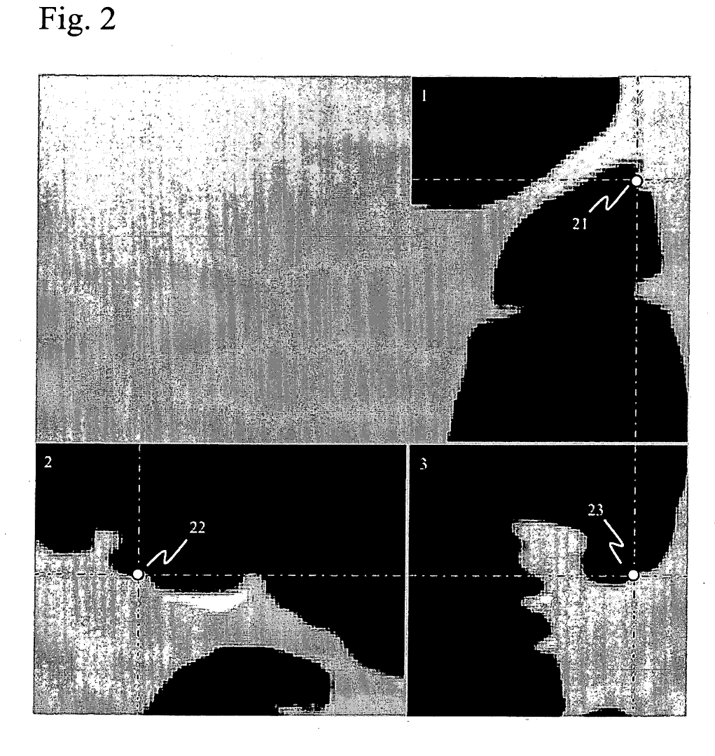

FIG. 2 is a sequence of views taken from CT medical image data illustrating a polyp candidate on a colon wall. The first view 1 is a sagittal view, the second view 2 is a coronal view, and the third view 3 is an axial view. Each view illustrates the same polyp candidate from a different perspective. In the sagittal view 1, the polyp candidate is identified by a point 21, in the coronal view 2, the polyp candidate is identified by a point 22, and in the axial view 3, the polyp candidate is identified with a point 23.

Then, one or more appropriately sized search spaces may be defined around each polyp candidate in each view (Step S54). Each search space may be centered on the identified points for each view. The size of the search space may be chosen to accommodate a polyp of a particular size. According to one exemplary embodiment, multiple search spaces of varying sizes may be defined for each candidate location. For each search space, the convex hull may be calculated and the three-dimensional size for each candidate may be determined, for example, according to the approaches discussed above.

The choice of search space size may be important in performing convex hull analysis. This is because the entire colon wall cross section may not be visible from every plane and thus, when looking at only a subsection of the colon wall that may include a polyp, it may be difficult to distinguish between the curvature of the colon wall and the curvature of the polyp if the search space is defined too small. If the search space is defined too big, other nearby structures, such as folds, may be included and would have to be separated from the polyp by the performance of additional processing steps.

Accordingly, the correct search analysis may be performed using multiple search spaces or an appropriately sized search space may be selected. In making the determination as to the desired size of the search area, assumptions as to the size and protrusion of an actual polyp are taken into account. For example, polyps may be known to be within a particular range of sizes and may be known to protrude to some degree into the lumen of the colon.

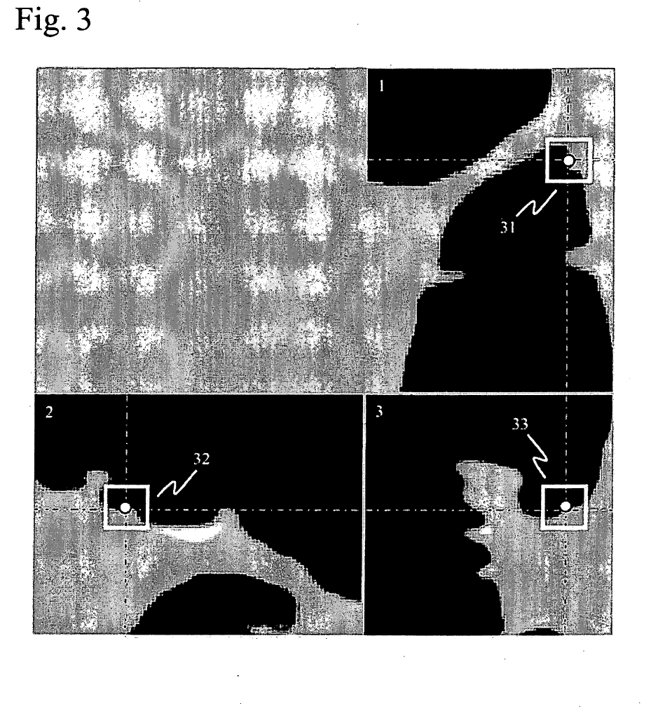

FIG. 3 is the sequence of views taken from CT medical image data of FIG. 2 wherein small search spaces are defined around the polyp candidate in each view. In the first view 1, a small search space 31 is defined, in the second view 2, a small search space 32 is defined, and in the third view 3, a small search space 33 is defined. In each of these views, the small search space is sufficiently small such that nearby structures such as folds are not included within the search space.

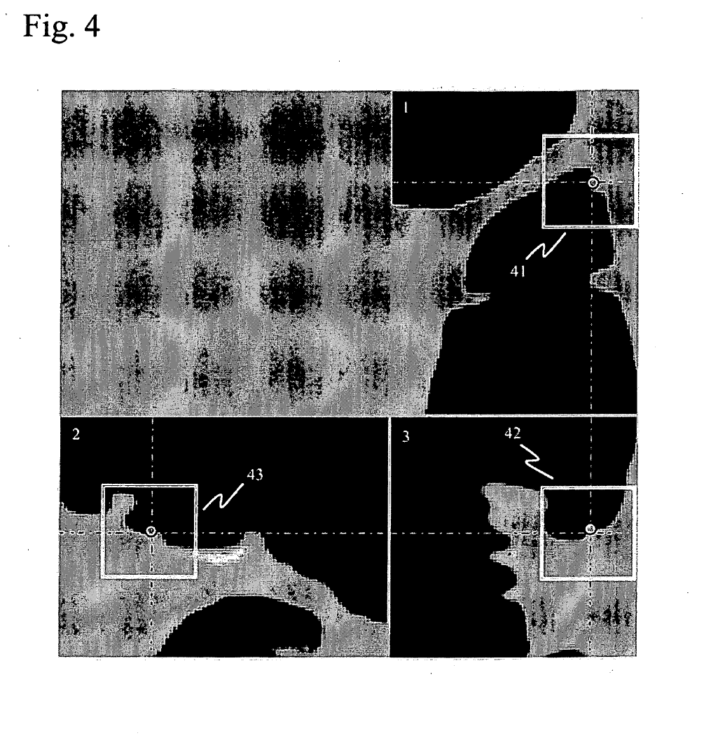

FIG. 4 is the sequence of views taken from CT medical image data of FIG. 2 wherein large search spaces are defined around the polyp candidate in each view. In the first view 1, a large search space 41 is defined, in the second view 2, a large search space 42 is defined, and in the third view 3, a large search space 43 is defined. In each of these views, the large search space is sufficiently large such that the curvature of the colon may be distinguished from the curvature of the polyp.

After the search spaces have been defined around the candidate locations for each view, the contour line of the colon wall may be determined (Strep S55). The contour of the colon wall may be defined as the set of surface pixels within the search space. For example, pixels of the colon wall that are adjacent to a pixel belonging to the lumen may be characterized as part of the surface pixels. Alternatively, a detagging algorithm may be used to determine pixels (voxels) on the colon wall when contrast material is present in the colon. Additionally, pixels on the border of the search space are be characterized as surface pixels where the colon wall is not found.

After the contour line has been determined, convex hull processing may be performed (Step S56) for one or more image planes within the search space such that all pixels of a given plane that fall interior to the polygon defined by the convex hull may be identified (Step S57). This may be repeated for each image plane and/or image view within each three-dimensional search space. The result of this approach may be a set of pixels within the convex hull from multiple planes.

After calculating the convex hull for each image plane in the search space and for each view (for example, the sagittal view, the coronal view, and the axial view) and determining all pixels that are located within the convex hull, the located pixels for each candidate location may be merged (Step S58). Merging may be performed, for example, by taking the union of all results or by selecting only those pixels that were inside the convex hull in at least some number of views, for example, two views or three views.

After the results of the multiple views have been merged, additional statistics may be derived from the segmented volume (Step S59). All of the pixels that fulfill the merging criteria may form a three-dimensional cloud of pixels. Statistics such as maximum distance between pixels, maximum extension, connectivity, shape, etc. may then be derived from each cluster. Additionally, statistical information pertaining to the segmented objects may include curvature analysis, size analysis, derivative analysis, and/or any other form of shape description analysis.

The statistical results of this step may then be presented to the medical practitioner, for example, along with other results of the CAD processing such that the medical practitioner may be able to use the statistical results to aid in rendering a diagnosis. Alternatively, the statistical results may be used by the CAD system to render an automatic diagnosis.

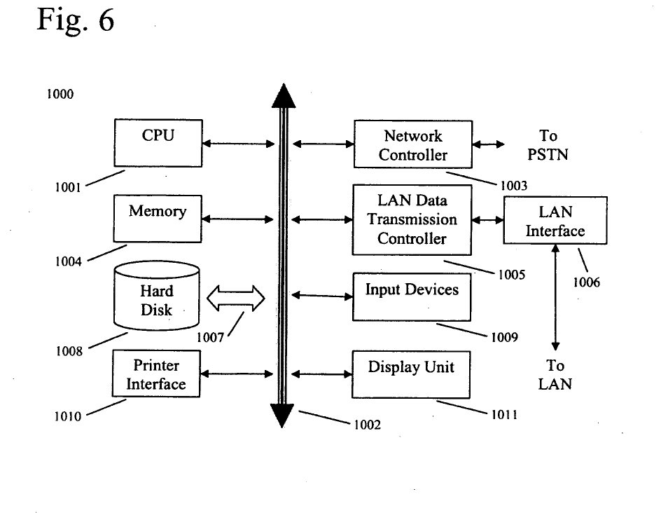

FIG. 6 shows an example of a computer system which may implement a method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002., and one or more input devices 1009, for example, a keyboard, mouse etc. As shown, the system 1000 may be connected to a data storage device, for example, a hard disk, 1008 via a link 1007.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

What is claimed is:

1. A method for performing computer-assisted diagnosis, comprising:
receiving medical image data;
defining a search space around one or more areas of analysis;
calculating a convex hull for each area of analysis within each search space;
determining a set of foreground pixels that are located within the convex hull for each area of analysis within each search space; and
calculating one or more properties concerning the areas of analysis based on the sets of foreground pixels within the convex hulls.

2. The method of claim 1, wherein one or more candidates are detected within the medical image data and the detected candidates comprise the one or more areas of analysis.

3. The method of claim 1, wherein the search space is a three-dimensional search space and the convex hull is calculated in three-dimensions.

4. The method of claim 1, wherein the search space is a three-dimensional search space and the convex hull is calculated in two-dimensions for a plurality of cut planes.

5. The method of claim 1, wherein the medical image data is CT image data, MR image data, ultrasound image data, or PET image data.

6. The method of claim 1, wherein the one or more areas of analysis are polyp candidates.

7. The method of claim 6, wherein the size of each defined search space is based on the approximate size of a polyp.

8. The method of claim 1, wherein the medical image data includes a plurality of views and a separate search space is defined around each area of analysis in each view, the convex hull is calculated for each area of analysis within each search space within each view, the sets of pixels located within the convex hull are determined for each area of analysis in each view, and the one or more properties concerning each area of analysis are calculated by first merging the sets of pixels of each particular candidate from all views.

9. The method of claim 8, wherein the plurality of views includes a sagittal view, a coronal view, and an axial view.

10. The method of claim 1, wherein the one or more properties concerning the areas of analysis includes a three-dimensional size of the area of analysis.

11. The method of claim 1, wherein the calculated one or more properties concerning the areas of analysis are used to render a diagnosis regarding each area of analysis.

12. The method of claim 1, wherein the medical image data includes a colon and the one or more areas of analysis are colonic polyp candidates.

13. A method for performing computer-assisted diagnosis, comprising:
receiving a plurality of two-dimensional views of an internal structure;
defining a search space around one or more areas of analysis within each view of the internal structure;
calculating a convex hull for each area of analysis within each search space of each view of the internal structure;
determining a set of foreground pixels that are located within the convex hull for each area of analysis within each search space within each view of the internal structure; and
for each area of analysis, merging the set of foreground pixels that are located within the convex hull from each view.

14. The method of claim 13, wherein one or more candidates are detected within the medical image data and the detected candidates comprise the one or more areas of analysis.

15. The method of claim 14, further including calculating a three-dimensional size for each candidate based on the corresponding merged set of pixels.

16. The method of claim 13, further including identifying one or more polyp candidates based on the merged set of pixels for each area of interest.

17. The method of claim 13, wherein the plurality of two-dimensional views of the structure are rendered from a three-dimensional medical image.

18. A computer system comprising:
a processor; and
a program storage device readable by the computer system, embodying a program of instructions executable by the processor to perform method steps for performing computer-assisted diagnosis, the method comprising:
receiving a plurality of two-dimensional views of an internal structure;
defining a search space around one or more areas of analysis within each view of the internal structure;
calculating a convex hull for each area of analysis within each search space of each view of the internal structure;
determining a set of foreground pixels that are located within the convex hull for each area if analysis within each search space within each view of the internal structure; and
for each area of analysis, merging the set of foreground pixels that are located within the convex hull from each view.

19. The computer system of claim 18, wherein the one or more areas of analysis are polyp candidates and a size of each defined search space is based on the approximate size of a polyp.

20. The computer system of claim 18, wherein the plurality of views includes a sagittal view, a coronal view, and an axial view.

21. A method for performing computer-assisted diagnosis, comprising:
receiving medical image data including a plurality of pixels;
characterizing each of the plurality of pixels as either foreground pixels or background pixels based on domain knowledge;
calculating a convex hull for the background pixels of the medical image data;
identifying the foreground pixels that are located interior to the {boundary} calculated convex hull; and
characterizing the identified foreground pixels that are located interior to the calculated convex hull as a region of suspicion.

22. A method for performing computer-assisted diagnosis, comprising:
receiving medical image data including a plurality of pixels;
characterizing each of the plurality of pixels as either foreground pixels or background pixels based on domain knowledge;
calculating a boundary of a convex hull for the background pixels of the medical image data;
identify background surface pixels that are not members of the boundary of the convex hull; and
characterizing the identified background surface pixels that are not members of the boundary of the convex hull as a region of suspicion.
